(19) United States
(12) Patent Application Publication
(10) Pub. No.: US 2004/0036561 A1
(43) Pub. Date: Feb. 26, 2004

(54) Magnet system for an electromechanical switching device and electromagnetic relay

(76) Inventor: Klaus Reiter, Dietmanns (AT)

Correspondence Address: Tyco Technology Resources, Suite 450, 4550 New Linden Hill Road, Wilmington, DE, 19808, US

(21) Appl. No.: 10/264,860

(22) Filed: Oct. 4, 2002

(30) Foreign Application Priority Data
Aug. 22, 2002 (EP) 01123872.2

(51) Int. Cl. H01H 51/22

(52) U.S. Cl. 335/80

(57) ABSTRACT

A magnet system for an electromechanical switching device. The magnet system having an electromagnetic coil system. An iron circuit having a core and a yoke partially surrounded by the electromagnetic coil system. The iron circuit having a magnetic field excited by the electromagnetic coil system. A permanent magnet arranged outside of the iron circuit that has field lines superimposed by the magnetic field of the electromagnetic coil system. The field lines of the permanent magnet strengthen the magnetic field of the electromagnetic coil system in a first region and weaken the magnetic field of the electromagnetic coil system in a second region such that the magnetic field in the first region and the magnetic field in the second region balance each other.

### BACKGROUND OF THE INVENTION

The invention relates to a magnet system for an electromechanical switching device and, more specifically, to a permanent magnet arrangement for an electromagnetic relay.

### DESCRIPTION OF THE PRIOR ART

Electromechanical switching devices, such as, relays and contactors, generally have the function of closing, or interrupting one or more electrical circuits on the basis of electrical control voltages that are applied to a magnet system. Electromechanical switching devices are used in a variety of applications including switching of high energy controlled by low energy, isolation of different voltage levels, e.g., low voltage on the input side and main voltage on the output side, isolation of direct current and alternating current circuits, simultaneous switching of a plurality of electrical circuits by means of a single control signal, and linking of information for establishing control sequences. The main fields of use for such electronic components are predominantly communications technology, automation and control technology, and motor vehicle electronics.

An important element of electromechanical switching devices is the magnet system that substantially consists of an electromagnetic coil system and an iron circuit. An electrical current flows through the coil system to excite a magnetic field in the iron circuit formed by a core, a yoke and an armature. The magnetic field actuates the armature such that the armature pivots in relation to a switching contact. An example of a magnet system of this type for use in an electromagnetic relay is taught in DE 199 17 338 A1.

The magnitude of the current required for actuating the armature corresponds to the energy consumption of the electromechanical switching device and the thermal loads occurring therein. In order to meet the demand for miniaturisation of electromechanical switching devices that is increasingly required in many fields of application, it is an essential aim of development to keep the required current as low as possible while raising the responsiveness of the magnet system.

It is generally known (see for example, Engineer's Relay Handbook, 5th edition, published by the National Association of Relay Manufacturers, NARM) that magnet systems, in which a permanent magnet has been included in the iron circuit, are more sensitive and respond more quickly than those without permanent magnets. An example of a conventional magnet system having a permanent magnet is shown in FIG. 7. FIG. 7 shows a magnet system 100 having an electromagnetic coil system 106 and an iron circuit 108. The electromagnetic coil system 106 consists of a coil body 104 and a coil winding 102 that induces a magnetic field in an iron circuit 108 when current flows through the electromagnetic coil system 106. The iron circuit 108 consists of a core 110, a yoke 112 and an armature 114. The armature 114 is drawn to pole surfaces 116, 118, 119 of the yoke 112 and the core 110. A permanent magnet 120 inserted in the iron circuit 108 strengthens the magnetic flux when current of the correct polarity is applied to the coil winding 102. When there is opposite polarity, the magnetic fields of the coil system 106 and the permanent magnet 120 counteract to weaken the actual effective magnetic field. If, therefore, the assistance of a permanent magnet is to be used for reducing the required coil current, the known arrangement shown in FIG. 7 can no longer be employed if simultaneously there is a requirement for complete autonomy from the polarity of the coil current.

It is therefore desirable to provide a magnet system for an electromechanical switching device in which the required coil current is reduced despite autonomy from the polarity of the coil current.

### SUMMARY OF THE INVENTION

The invention relates to a magnet system for an electromechanical switching device. The magnet system comprising an electromagnetic coil system, an iron circuit, and a permanent magnet. The iron circuit is partially surrounded by the electromagnetic coil system and has a magnetic field excited by the electromagnetic coil system. The permanent magnet is arranged outside of the iron circuit and has field lines superimposed by the magnetic field of the electromagnetic coil system.

### BRIEF DESCRIPTION OF THE DRAWINGS

FIG. 1 is a cross-sectional view of a magnet system according to a first embodiment;

FIG. 2 is a perspective view of the magnet system according to the first embodiment;

FIG. 3 is a schematic view of a magnetic field in the magnet system according to the first embodiment with current being applied to a coil in a first direction;

FIG. 4 is a schematic view of the magnetic field in the magnet system of FIG. 3 with current being applied to the coil in a second direction;

FIG. 5 is a schematic view of a magnetic field in a magnet system according to a second embodiment with current being applied to a coil in a first direction;

FIG. 6 is a schematic view of the magnetic field in the magnet system of FIG. 5 with current being applied to the coil in a second direction;

FIG. 7 is a cross-sectional view of a conventional magnetically polarised magnet system.

### DETAILED DESCRIPTION OF THE PREFERRED EMBODIMENT

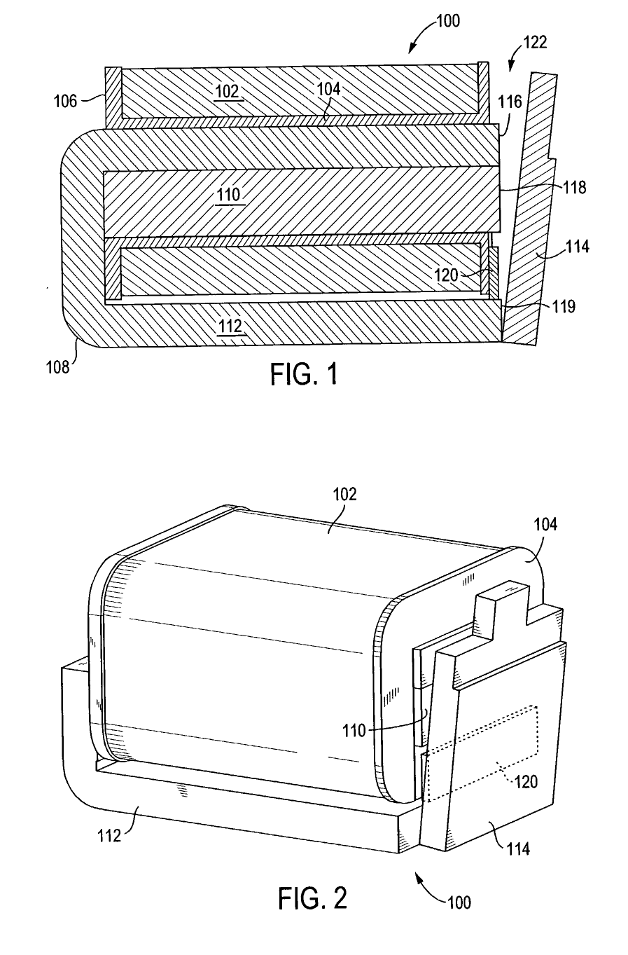

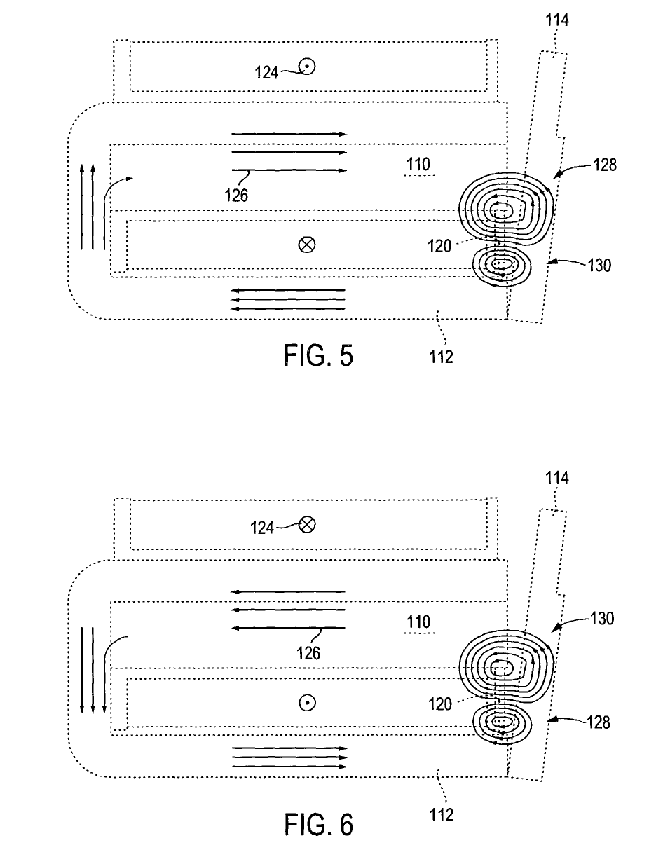

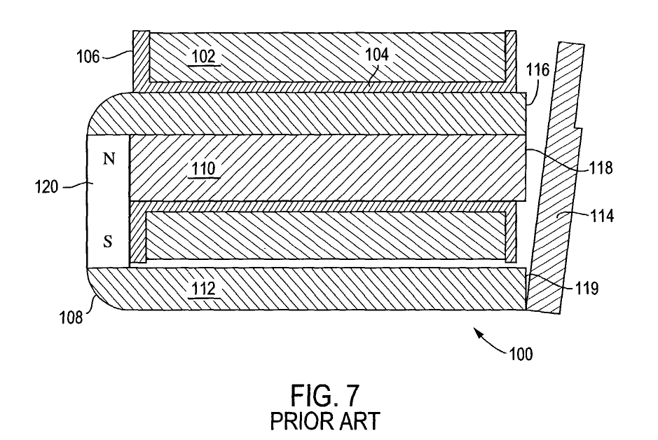

FIGS. 1 through 4 show a magnet system 100 for an electromechanical switching device in accordance with a first embodiment of the invention. FIGS. 5 and 6 show the magnet system 100 for the electromechanical switching device in accordance with a second embodiment of the invention. For the sake of clarity, elements that are unimportant for illustrating the invention, for example, supply leads, housing components, etc., are not represented in the Figs.

Shown in FIGS. 1 and 2, the magnet system 100 has a permanent magnet 120, an electromagnetic coil system 106 and an iron circuit 108. The electromagnetic coil system 106 consists of a coil body 104 and a coil winding 102. The iron circuit 108 consists of a core 110, a yoke 112 and an armature 114. The core 110 has a pole surface 118 positioned substantially adjacent to the armature 114. The yoke 112 is substantially unshaped and has pole surfaces 116, 119 positioned substantially adjacent to the armature 114. A working air gap 122 is provided between the pole surfaces 116, 118, 119 and the armature 114 and substantially parallel to the permanent magnet 120. As shown by the dashed lines in FIG. 2, the permanent magnet 120 is a substantially rectangular plate and extends parallel to the pole surface 118 of the core 110 with substantially corresponding dimensions. The width of the permanent magnet 120 corresponds approximately to the width of the armature 114. The permanent magnet 120 is in contact with an end face of the coil body 104 and, in the first embodiment, an arm of the yoke 112 that is not surrounded by the coil 106.

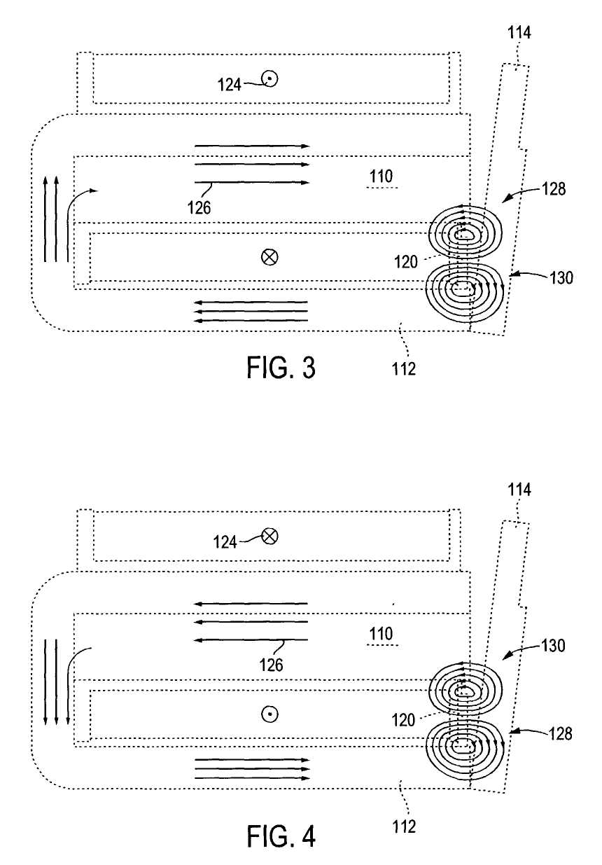

The operation of the magnet system 100 for the electromechanical switching device in accordance with the first embodiment of the invention will now be described in greater detail with reference to FIGS. 3 and 4. Arrows representing magnetic field lines 126 are shown schematically owing to a first and a second direction of coil current 124. Herein a circle with a dot at the center describes the directional arrow of the coil current 124 which flows out of the drawing plane, and a circle with a cross describes the directional arrow of the coil current 124 flowing into the drawing plane. Field lines of the permanent magnet 120 are represented by regions 128, 130.

By means of the coil current 124 which flows through the coil winding 102, a magnetic field is induced in the iron circuit 108 that pulls the armature 114 in the direction of the pole surfaces 116, 118, 119 of the yoke 112 and the core 110. The permanent magnet 120 assists the movement of the armature 114 in the direction of the core 110 by means of its magnetic attraction.

In cases where the direction of the coil current 124 flows as shown in FIG. 3, in the region 128 a field weakening occurs because the magnetic field lines 126 run counter to the field lines of the permanent magnet 120. In the region 130 a field strengthening occurs because the magnetic field lines 126 run in the same direction as the field lines of the permanent magnet 120.

If the direction of the coil current 124 is reversed, as shown in FIG. 4, the direction of the magnetic field lines 126 are also reversed. The region 130 of field strengthening is now located in the environment of the core 110 because the magnetic field lines 126 run in the same direction as the field lines of the permanent magnet 120. The region 128 of field weakening occurs in the environment of the yoke 112 because the magnetic field lines 126 run counter to the field lines of the permanent magnet 120.

In the configuration and arrangement of the permanent magnet 120 shown in FIGS. 1 through 4, the region 130 of field strengthening and the region 129 of field weakening are approximately balanced in respect to one another to create a drive system approximately independent of the polarity of the magnetic field and, thus, of the polarity of the voltage and of the direction of the coil current 124. The magnet system 100 reacts to the change of polarity of the magnetic field like a drive system without assistance from the permanent magnet 120. Because of the magnetic attraction of the armature 114 to the permanent magnet 120, however, the magnet system 100 has improved responsiveness. In this manner the energy requirement for controlling the magnet system 100 can be greatly reduced. Further, by displacing the permanent magnet 120 in the direction of the core 110, the magnet system 100 may be finely adjusted.

FIGS. 5 and 6 show a magnet system 100 for the electromechanical switching device in accordance with the second embodiment of the invention. FIGS. 5 and 6 show a maximum possible displacement position of the permanent magnet 120, in which the permanent magnet 120 is positioned in contact with the core 110. The relationship between the region 128 of field weakening and the region 130 of field strengthening may be influenced by means of such geometric displacement.

The invention is based on the fact that advantageous pick-up and pull-through characteristics can be achieved by the use of the permanent magnet 120 and at the same time autonomy of the switching characteristics from the polarity can be achieved if the permanent magnet 120 is arranged outside the iron circuit 108.

If the permanent magnet 120 is positioned and constructed in respect to its geometry and dimensions such that the field lines of the permanent magnet 120 strengthen the field of the electromagnetic coil system 106 in one region and weaken the field of the electromagnetic coil system 106 in another region and that these two effects balance each other, then the system reacts to a change of polarity of the main magnetic field exactly like a drive system without the assistance of a permanent magnet 120, without thereby losing the improvement in sensitivity of the magnet system 100 based on the magnetic attraction of the armature 114 to the permanent magnet 120. The attraction of the armature 114 to the permanent magnet 120 may be adjusted, for example, by altering the thickness of the permanent magnet 120, the strength of the permanent magnet 120, or by altering the size of the working air gap 122 between the closed armature 114 and the permanent magnet 120.

The arrangement of the permanent magnet 120 in the working air gap 122 between the core 110 and the armature 114 enables the field lines of the permanent magnet 120 to directly influence the characteristics of the armature 114. The design of the permanent magnet 120 as a rectangular plate also represents a solution that is advantageous and physically effective in terms of production.

In the case of a magnet system 100 in which the core 110 and the yoke 112 have respective pole surfaces 116, 118, 119 lying in a common plane, the fact that the permanent magnet 120 is arranged parallel to the pole surfaces 116, 118, 119 and between the pole surfaces 118, 119 means that fine adjustment of the magnet system 100 is rendered possible by means of displacing the permanent magnet 120 on this plane.

An embodiment suitable for substantial miniaturisation is represented by a magnet system 100 in which the yoke 112 has a substantially U-shaped configuration and in which an arm of the yoke 112 is enclosed at least partially by the electromagnetic coil system 106. The core 110 is designed as a core plate that makes contact with an arm of the yoke 112 enclosed by the electromagnetic coil system 106 and also dips into the electromagnetic coil system 106 such that further miniaturisation of the magnet system 100 can be achieved.

The magnet system 100 according to the invention can be employed particularly effectively in the case of an electromagnetic relay which has an actuation element or a switching contact and at least one fixed contact, the switching contact being able to come into contact with the fixed contact by means of the movement of the armature 114. In particular in the case of greatly miniaturised safety relays, the saving on energy is manifested by the increased sensitivity of the magnet system 100.

I/We claim:

1. A magnet system for an electromechanical switching device comprising:
an electromagnetic coil system;
an iron circuit partially surrounded by the electromagnetic coil system and having a magnetic field excited by the electromagnetic coil system; and
a permanent magnet arranged outside of the iron circuit having field lines superimposed by the magnetic field of the electromagnetic coil system.

2. The magnet system of claim 1, wherein the permanent magnet is positioned such that the field lines of the permanent magnet strengthen the magnetic field of the electromagnetic coil system in a first region and weaken the magnetic field of the electromagnetic coil system in a second region.

3. The magnet system of claim 2, wherein the magnetic field in the first region and the magnetic field in the second region balance each other.

4. The magnet system of claim 1, wherein the permanent magnet is formed as a substantially rectangular plate.

5. The magnet system of claim 1, wherein the iron circuit includes a yoke, a core, and a moveable armature.

6. The magnet system of claim 5, wherein the permanent magnet is positioned between the core and the yoke and adjacent to the armature.

7. The magnet system of claim 5, wherein the core and the yoke have substantially parallel pole surfaces arranged in a same plane and the permanent magnet is arranged parallel to and in the same plane as the pole surfaces.

8. The magnet system of claim 5, wherein the core and the yoke have pole surfaces positioned adjacent to the armature.

9. The magnet system of claims 5, wherein the yoke has a substantially U-shaped configuration and an arm at least partially enclosed by the electromagnetic coil system.

10. A magnet system for an electromechanical switching device comprising:
an electromagnetic coil system having a coil body and a coil winding;
an iron circuit having a yoke and a core partially surrounded by the electromagnetic coil system and a magnetic field excited by the electromagnetic coil system;
a moveable armature; and
a permanent magnet arranged outside of the iron circuit having field lines superimposed by the magnetic field of the electromagnetic coil system such that the field lines of the permanent magnet strengthen the magnetic field of the electromagnetic coil system in a first region and weaken the magnetic field of the electromagnetic coil system in a second region.

11. The magnet system of claim 10, wherein the core contacts an arm of the yoke that is surrounded by the electromagnetic coil system.

12. The magnet system of claim 10, wherein the permanent magnet contacts the coil body.

13. The magnet system of claim 12, wherein the permanent magnet contacts an arm of the yoke not surrounded by the electromagnetic core.

14. The magnet system of claim 12, wherein the permanent magnet contacts the core.

15. A magnet system for an electromechanical switching device comprising:
an electromagnetic coil system having a coil body and a coil winding;
an iron circuit having a yoke and a core partially surrounded by the electromagnetic coil system and a magnetic field excited by the electromagnetic coil system; and
a permanent magnet positioned between the electromagnetic coil system and a moveable armature.

16. The magnet system of claim 15, wherein the permanent magnet is positioned such that the field lines of the permanent magnet strengthen the magnetic field of the electromagnetic coil system in a first region and weaken the magnetic field of the electromagnetic coil system in a second region.

17. The magnet system of claim 16, wherein the magnetic field in the first region and the magnetic field in the second region balance each other.

18. The magnet system of claim 15, wherein the permanent magnet contacts the coil body.

19. The magnet system of claim 15, wherein the permanent magnet contacts an arm of the yoke.

20. The magnet system of claim 15, wherein the permanent magnet contacts the core.
